(19) United States
(12) Patent Application Publication
(10) Pub. No.: US 2026/0264730 A1
(43) Pub. Date: Sep. 10, 2026

(54) CONTROL DEVICE, CONTROL SYSTEM, AND MESSAGE DELAY DETECTION METHOD

(71) Applicant: Mitsubishi Electric Corporation, Chiyoda-ku, Tokyo (JP)

(72) Inventors: Masashi ASUKA, Tokyo (JP); Sachi ITAGAKI, Tokyo (JP); Makoto TOKUMARU, Tokyo (JP)

(73) Assignee: Mitsubishi Electric Corporation, Chiyoda-ku, Tokyo (JP)

(21) Appl. No.: 18/994,837

(22) PCT Filed: Aug. 23, 2022
(86) PCT No.: PCT/JP2022/031729

§ 371 Date: Jan. 15, 2025

(51) Int. Cl. B61L 27/70

(52) U.S. Cl. CPC B61L 27/70

(57) ABSTRACT

A control device as a second control device in a control system in which a first control device and the second control device exchange messages via a communication device, includes a communication unit receiving a first message from the first control device via the communication device, and transmitting a second message to the first control device via the communication device, a delay detection unit detecting delay in the first message, using first time information when the first message is transmitted, the first time information being based on first expiration time of the first control device and added to the first message, and second time information when the first message is received or the second message is transmitted, the second time information being based on second expiration time of the control device different from the first expiration time, and a time measuring unit measuring time using the second expiration time.

### FIELD

The present disclosure relates to a control device, a control system, and a message delay detection method used in train control.

### BACKGROUND

There has been a system in which a plurality of devices mutually exchange messages to control a train or the like. If a delay occurs in the transmission and reception of a message while the plurality of devices exchange messages, a certain device may control the train using the delayed message transmitted from another device, resulting in a failure in the control of the train. To this problem, Patent Literature 1 discloses a technique in which a plurality of slave communication devices communicate with one master communication device in different communication cycles in a system in which the master communication device transmits and receives data to and from the plurality of slave communication devices. The system described in Patent Literature 1, in which the plurality of slave communication devices communicate with the master communication device in the different communication cycles, can thus avoid the occurrence of congestion and the like to prevent the occurrence of delays.

In some systems in which a plurality of devices mutually exchange messages to control a train or the like, a communication device such as a hub relays communications on the way between the devices. If a failure occurs in the communication device on the way in this system, a delay may also occur in the transmission and reception of a message between the devices. Methods to detect a delay caused by the communication device or the like between the devices include a method using time information included in messages by the devices adding the time information to the messages to be transmitted, time information when the devices receive messages, and the like.

Specifically, for each message, a device A adds time information of the transmission time of the message to the message to be transmitted from the device A. The device A adds time information of the transmission time of a message transmitted from a device B included in the message acquired from the device B to a message to be transmitted from the device A as ACKNOWLEDGE information. The device B acquires a plurality of messages from the device A. If a time difference obtained by comparing the transmission time of a previous message with the transmission time of a current message is proper with respect to a message reception time interval measured with a clock of the device B, the device B determines that the message is not delayed. However, in a case where the plurality of messages from the device A have the same delay time, the device B cannot detect delays. Therefore, the device B compares ACKNOWLEDGE information included in a message from the device A with a current time measured by the device B. If the time difference is sufficiently small, the device B determines that the message received from the device A is sufficiently new and the message is not delayed.

### CITATION LIST

### Patent Literature

Patent Literature 1: WO 2020/095413 A

### SUMMARY OF INVENTION

### Problem to be Solved by the Invention

To achieve quick delivery, control messages are limited in the length of a field that can be used for time information or the like. For example, in a case where a measurement time reaches an expiration time in 24 hours, the clock starts from zero after 24 hours. Under this limit, when a message transmitted from the device A that has been held in a communication device such as a hub between the devices for exactly 24 hours is output to the device B, the device B cannot detect that the received message was transmitted from the device A 24 hours ago. That is, there is a problem in that the device B cannot detect that the received message is delayed.

Here, the above problem can be solved by increasing the amount of information, that is, the number of bits of time information to be added to a message to express the time information in the Gregorian calendar or the like. However, when the number of bits for time information is increased in messages to be transmitted and received between the devices, communication time increases and communication cost also increases. Furthermore, it is not easy to change the configuration of messages because it is considered that existing systems for controlling trains or the like handle time information with a fixed expiration time.

The present disclosure has been made in view of the above, and an object thereof is to provide a control device that can detect a delay in a received message without increasing the amount of information in messages.

### Means to Solve the Problem

In order to solve the above-described problems and achieve the object, a control device according to the present disclosure is a control device that is a second control device in a control system in which a first control device and the second control device transmit and receive a message via a communication device. The control device includes: a communication unit to receive a first message that is the message transmitted from the first control device via the communication device, and transmit a second message that is the message to the first control device via the communication device; a delay detection unit to detect a delay in the first message, using first time information when the first message is transmitted, the first time information being based on a first expiration time of the first control device and added to the first message, and second time information when the first message is received or the second message is transmitted, the second time information being based on a second expiration time of the control device different from the first expiration time; and a time measuring unit to measure time using the second expiration time.

### Effects of the Invention

The control device of the present disclosure has an advantage of being able to detect a delay in a received message without increasing the amount of information in messages.

### BRIEF DESCRIPTION OF DRAWINGS

FIG. 1 is a diagram illustrating an exemplary configuration of a control system according to a first embodiment.

FIG. 2 is a diagram illustrating an exemplary configuration of a control device according to the first embodiment.

FIG. 3 is a first sequence diagram illustrating, as a comparative example, how control devices transmit and receive messages via a communication device, using time information with the same expiration time.

FIG. 4 is a second sequence diagram illustrating, as a comparative example, how the control devices transmit and receive messages via the communication device, using time information with the same expiration time.

FIG. 5 is a sequence diagram illustrating how the control devices according to the first embodiment transmit and receive messages via the communication device, using time information with different expiration times.

FIG. 6 is a flowchart illustrating an operation to detect a delay in a received message performed by the control device according to the first embodiment.

FIG. 7 is a diagram illustrating an exemplary configuration of processing circuitry in the case where a processor and a memory constitute processing circuitry to implement the control device according to the first embodiment.

FIG. 8 is a diagram illustrating an example of processing circuitry in the case where dedicated hardware constitutes the processing circuitry to implement the control device according to the first embodiment.

FIG. 9 is a flowchart illustrating an operation to detect a change in the expiration time of a control device that is the source of messages, performed by a control device according to a second embodiment.

FIG. 10 is a diagram illustrating an example of an expiration time management table held by a delay detection unit of the control device according to the second embodiment.

### DESCRIPTION OF EMBODIMENTS

Hereinafter, a control device, a control system, and a message delay detection method according to embodiments of the present disclosure will be described in detail with reference to the drawings.

### First Embodiment

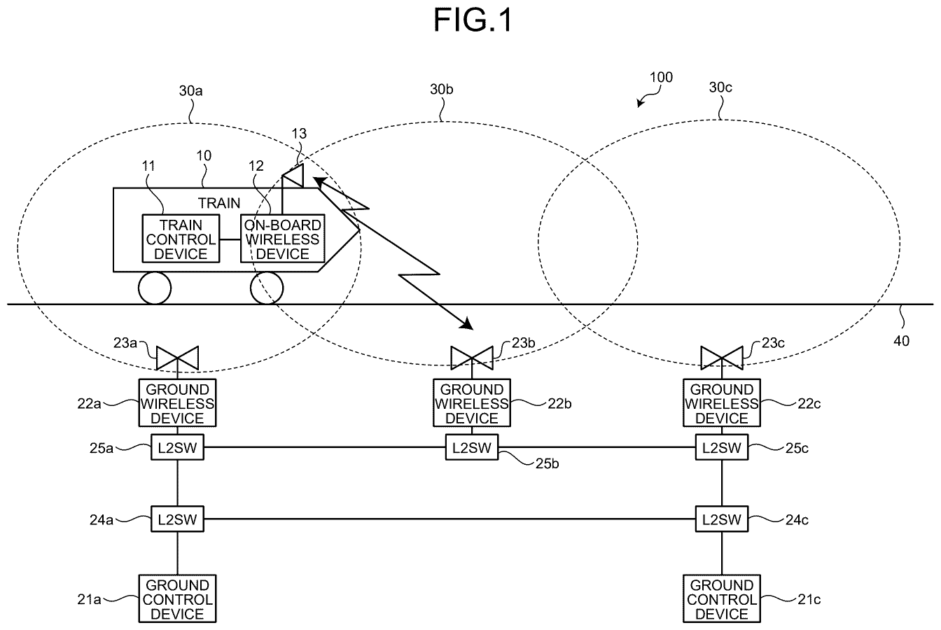

FIG. 1 is a diagram illustrating an exemplary configuration of a control system 100 according to a first embodiment. The control system 100 is a system in which a train control device 11 and ground control devices 21a and 21c exchange messages, that is, perform communication to control the travel of a train 10. The control system 100 includes the train 10, the ground control devices 21a and 21c, layer 2 switches 24a, 24c, and 25a to 25c, ground wireless devices 22a to 22c, and antennas 23a to 23c. The ground wireless devices 22a to 22c and the antennas 23a to 23c are installed along a track 40 on which the train 10 travels. A communication area 30a is formed by the antenna 23a connected to the ground wireless device 22a. A communication area 30b is formed by the antenna 23b connected to the ground wireless device 22b. A communication area 30c is formed by the antenna 23c connected to the ground wireless device 22c. In the example of FIG. 1, the train 10 travels through the communication area 30a, the communication area 30b, and the communication area 30c in this order.

The train 10 includes the train control device 11, an on-board wireless device 12, and an antenna 13. Although the antenna 13 is outside the train 10 in FIG. 1, the antenna 13 is also included in the train 10. The train control device 11 transmits generated messages to the ground control devices 21a and 21c via the on-board wireless device 12 and the antenna 13. The ground control devices 21a and 21c receive the messages transmitted from the train control device 11 via the antennas 23a to 23c, the ground wireless devices 22a to 22c, the layer 2 switches 24a, 24c, and 25a to 25c, and the like. The ground control devices 21a and 21c transmit generated messages to the train control device 11 via the layer 2 switches 24a, 24c, and 25a to 25c, the ground wireless devices 22a to 22c, the antennas 23a to 23c, and the like. The train control device 11 receives the messages transmitted from the ground control devices 21a and 21c via the antenna 13 and the on-board wireless device 12.

In the present embodiment, the train control device 11 detects delays in messages from the ground control devices 21a and 21c received via the layer 2 switches 24a, 24c, and 25a to 25c, the ground wireless devices 22a to 22c, the antennas 23a to 23c, the antenna 13, the on-board wireless device 12, and the like. Similarly, the ground control devices 21a and 21c detect delays in messages from the train control device 11 received via the on-board wireless device 12, the antenna 13, the antennas 23a to 23c, the ground wireless devices 22a to 22c, the layer 2 switches 24a, 24c, and 25a to 25c, and the like. The train control device 11 and the ground control devices 21a and 21c measure time using different expiration times for time information to be added to a message to be transmitted and time information when a message is received.

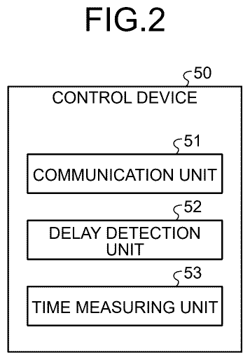

The train control device 11 and the ground control devices 21a and 21c are different in configuration to control the travel of the train 10, but are the same in configuration to detect message delays. In the present embodiment, only the detection of a message delay will be described. Therefore, the train control device 11 and the ground control devices 21a and 21c are referred to as control devices 50 when not distinguished. The configuration and operation of the control devices 50 will be described. FIG. 2 is a diagram illustrating an exemplary configuration of each control device 50 according to the first embodiment. The control device 50 includes a communication unit 51, a delay detection unit 52, and a time measuring unit 53. The control device 50 is a second control device in the control system 100 in which a first control device and the second control device transmit and receive messages via a communication device. The first control device and the second control device are the control devices 50. The communication device represents the on-board wireless device 12, the ground wireless devices 22a to 22c, the layer 2 switches 24a, 24c, and 25a to 25c, and the like. The communication device may be composed of a plurality of communication devices. For example, in the case where the first control device is the train control device 11, the second control device is the ground control device 21a or the ground control device 21c. In the case where the first control device is the ground control device 21a or the ground control device 21c, the second control device is the train control device 11.

The communication unit 51 receives a first message that is a message transmitted from the first control device via the communication device, and transmits a second message that is a message to the first control device via the communication device.

The delay detection unit 52 detects a delay in the first message, using first time information when the first message was transmitted, the first time information being based on a first expiration time of the first control device and added to the first message, and second time information when the first message was received or the second message was transmitted, the second time information being based on a second expiration time of the control device 50 different from the first expiration time.

The time measuring unit 53 measures time using the second expiration time.

In the present embodiment, the first expiration time of the first time information when the first message was transmitted which is added to the first message transmitted by the first control device is different from the second expiration time of the second time information when the second control device received the first message or transmitted the second message.

Next, an operation performed by the two control devices 50 to transmit and receive messages via the communication device will be described. Here, to describe the need for a plurality of the control devices 50 to measure time using different expiration times, a description is given, as a comparative example, of how messages are transmitted and received in the case where the plurality of control devices 50 measure time using the same expiration time.

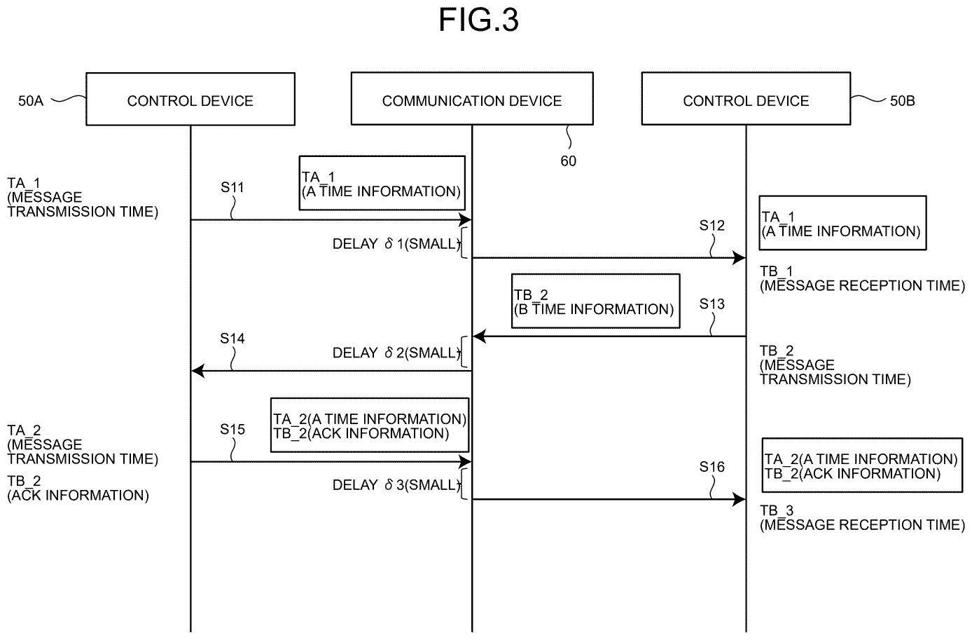

FIG. 3 is a first sequence diagram illustrating, as a comparative example, how control devices 50A and 50B transmit and receive messages via a communication device 60, using time information with the same expiration time. In FIG. 3, the control device 50A corresponds to the first control device, the control device 50B corresponds to the second control device, and the communication device 60 corresponds to the communication device. The communication device 60 only needs to be located between the control device 50A as the first control device and the control device 50B as the second control device, and thus may be composed of a plurality of devices as in the example of FIG. 1. In FIG. 3, when the control device 50A is the train control device 11, the control device 50B is the ground control device 21a or the ground control device 21c. When the control device 50A is the ground control device 21a or the ground control device 21c, the control device 50B is the train control device 11.

First, the communication unit 51 of the control device 50A adds first time information TA_1 that is transmission time information to a first message that is a message to be transmitted, and transmits the first message (step S11). The transmission time may be the time at which the first message is generated. The same applies to the following. The communication device 60 relays the first message transmitted from the control device 50A to the control device 50B with a delay time of delay δ1 (step S12). The time measuring unit 53 of the control device 50B measures the time at which the first message transmitted from the control device 50A and relayed by the communication device 60 is received as second time information TB_1.

The communication unit 51 of the control device 50B adds second time information TB_2 that is transmission time information to a second message that is a message to be transmitted, and transmits the second message (step S13). The transmission time may be the time at which the second message is generated. The same applies to the following. The communication device 60 relays the second message transmitted from the control device 50B to the control device 50A with a delay time of delay δ2 (step S14). The communication unit 51 of the control device 50A receives the second message transmitted from the control device 50B and relayed by the communication device 60.

The communication unit 51 of the control device 50A adds first time information TA_2 that is transmission time information and the second time information TB_2 added to the second message as ACKNOWLEDGE information to a first message that is a message to be transmitted, and transmits the first message (step S15). In FIG. 3, the ACKNOWLEDGE information is represented as ACK information. The same applies to the following. The communication device 60 relays the first message transmitted from the control device 50A to the control device 50B with a delay time of delay δ3 (step S16). The time measuring unit 53 of the control device 50B measures the time at which the first message transmitted from the control device 50A and relayed by the communication device 60 is received as second time information TB_3.

The delay detection unit 52 of the control device 50B uses the first time information TA_1 and TA_2 and the second time information TB_1, TB_2, and TB_3 to determine whether or not formula (1) for checking the time information of the control device 50A and formula (2) for checking the ACKNOWLEDGE information are satisfied.

$$\vert ( TB\_ 3 - TB\_ 1 ) - ( TA\_ 2 - TA\_ 1 ) \vert = δ3 - δ1 < ε1 \qquad ( 1 )$$

$$TB\_ 3 - TB\_ 2 < ε2 \qquad ( 2 )$$

ε1 in formula (1) is a specified first delay threshold, and ε2 in formula (2) is a specified second delay threshold. If formulas (1) and (2) are satisfied, the delay detection unit 52 of the control device 50B determines that no delay has occurred in the first message transmitted from the control device 50A. If at least one of formula (1) or (2) is not satisfied, the delay detection unit 52 of the control device 50B determines that a delay has occurred in the first message transmitted from the control device 50A.

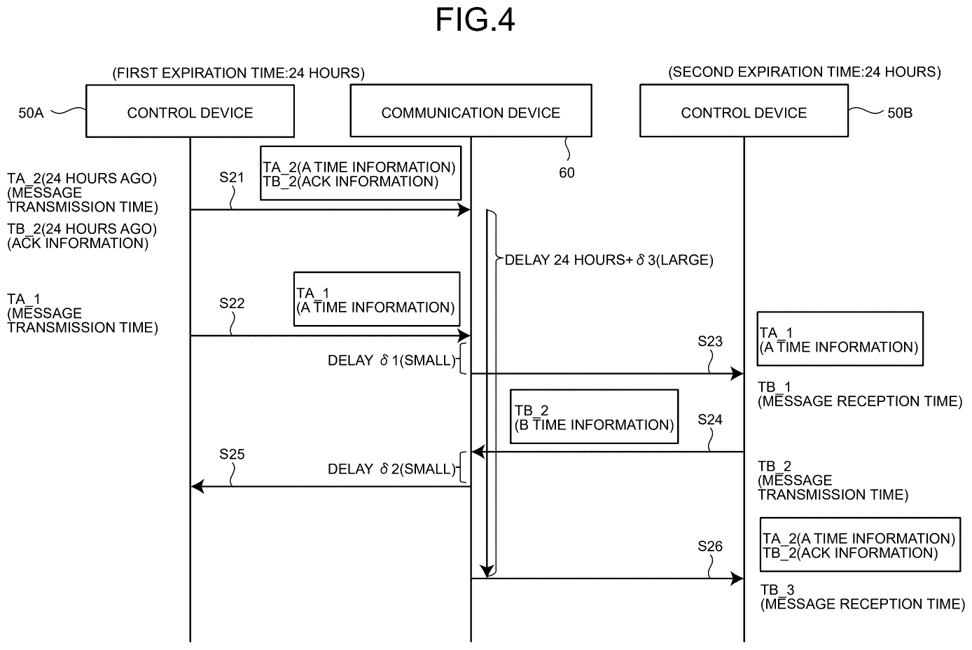

Next, a description is given of a case in which in FIG. 3, the first expiration time of the first time information measured by the time measuring unit 53 of the control device 50A and the second expiration time of the second time information measured by the time measuring unit 53 of the control device 50B are both 24 hours, and in the communication device 60, the first message transmitted from the control device 50A is held, that is, delayed 24 hours longer than a normal delay time of delay δ3 and transmitted to the control device 50B. FIG. 4 is a second sequence diagram illustrating, as a comparative example, how the control devices 50A and 50B transmit and receive messages via the communication device 60, using time information with the same expiration time.

First, approximately 24 hours before operation in and after step S22 described below, the communication unit 51 of the control device 50A receives a second message as in step S14 illustrated in FIG. 3, and as in step S15 illustrated in FIG. 3, adds first time information TA_2 that is transmission time information and second time information TB_2 added to the second message as ACKNOWLEDGE information to a first message that is a message to be transmitted, and transmits the first message (step S21). However, the first message transmitted from the control device 50A in step S21 is held 24 hours longer than usual in the communication device 60.

The communication unit 51 of the control device 50A adds first time information TA_1 that is transmission time information to a first message that is a message to be transmitted, and transmits the first message (step S22). Assume that the first time information TA_1 added to the first message in step S22 is approximately 24 hours after the first time information TA_2 added to the first message in step S21, and the first expiration time has expired once between the first time information TA_2 in step S21 and the first time information TA_1 in step S22.

The communication device 60 relays the first message transmitted from the control device 50A to the control device 50B with a delay time of delay δ1 (step S23). The time measuring unit 53 of the control device 50B measures the time at which the first message transmitted from the control device 50A and relayed by the communication device 60 is received as second time information TB_1. Assume that the second time information TB_1, which is the reception time of the first message in step S23, is approximately 24 hours after the second time information TB_2 added to the first message in step S21, and the second expiration time has expired once between the second time information TB_2 in step S21 and the second time information TB_1 in step S23.

The communication unit 51 of the control device 50B adds second time information TB_2 that is transmission time information to a second message that is a message to be transmitted, and transmits the second message (step S24). The communication device 60 relays the second message transmitted from the control device 50B to the control device 50A with a delay time of delay δ2 (step S25). The communication unit 51 of the control device 50A receives the second message transmitted from the control device 50B and relayed by the communication device 60.

Here, the communication device 60 relays the first message that has been received from the control device 50A in step S21 to the control device 50B with a delay time of 24 hours+delay δ3 (step S26). The time measuring unit 53 of the control device 50B measures the time at which the first message transmitted from the control device 50A and relayed by the communication device 60 is received as second time information TB_3.

As in the case of the example of FIG. 3, the delay detection unit 52 of the control device 50B uses the first time information TA_1 and TA_2 and the second time information TB_1, TB_2, and TB_3 to determine whether or not formula (1) for checking the time information of the control device 50A and formula (2) for checking the ACKNOWLEDGE information are satisfied. At this time, formula (1) is actually as follows. Formula (2) is the same as that described above, and thus a description thereof is omitted.

$$\vert ( TB\_ 3 - TB\_ 1 ) - ( TA\_ 2 - TA\_ 1 ) \vert = MOD ( 24 + δ3 , 24 ) - δ1 = δ3 - δ1 < ε1 \qquad ( 1 )$$

Thus, in the case where a delay of the same time as the first expiration time of the control device 50A and the second expiration time of the control device 50B has occurred in the communication device 60, the delay detection unit 52 of the control device 50B cannot detect that the delay has occurred in the communication device 60. That is, the delay detection unit 52 of the control device 50B recognizes the first time information TA_2 and the second time information TB_2 as the ACKNOWLEDGE information added to the first message received in step S26, which are actually approximately 24 hours ago, as the latest time information.

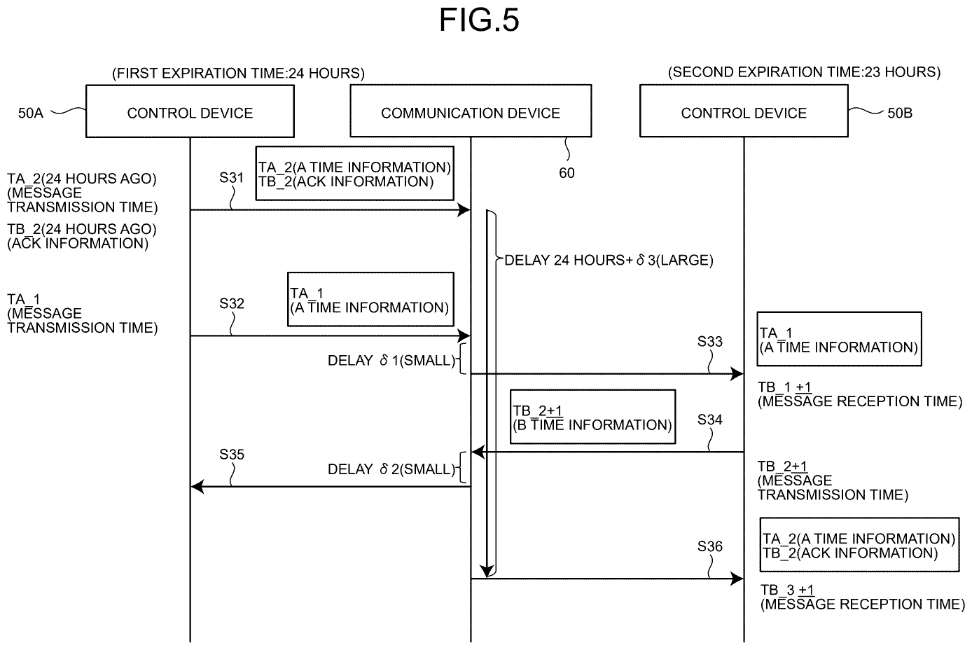

Therefore, in the present embodiment, the first expiration time of the control device 50A and the second expiration time of the control device 50B are set to different expiration times. FIG. 5 is a sequence diagram illustrating how the control devices 50A and 50B according to the first embodiment transmit and receive messages via the communication device 60, using time information with different expiration times. In FIG. 5, the first expiration time of the control device 50A is set to 24 hours, and the second expiration time of the control device 50B is set to 23 hours. Assume that the holding time of the first message in the communication device 60 is 24 hours longer than a usual delay time of delay δ3 as in the case of the example of FIG. 4.

First, approximately 24 hours before operation in and after step S32 described below, the communication unit 51 of the control device 50A receives a second message as in step S14 illustrated in FIG. 3, and as in step S15 illustrated in FIG. 3, adds first time information TA_2 that is transmission time information and second time information TB_2 added to the second message as ACKNOWLEDGE information to a first message that is a message to be transmitted, and transmits the first message (step S31). However, the first message transmitted from the control device 50A in step S31 is held 24 hours longer than usual in the communication device 60.

The communication unit 51 of the control device 50A adds first time information TA_1 that is transmission time information to a first message that is a message to be transmitted, and transmits the first message (step S32). Assume that the first time information TA_1 added to the first message in step S32 is approximately 24 hours after the first time information TA_2 added to the first message in step S31, and the first expiration time has expired once between the first time information TA_2 in step S31 and the first time information TA_1 in step S32.

The communication device 60 relays the first message transmitted from the control device 50A to the control device 50B with a delay time of delay δ1 (step S33). The time measuring unit 53 of the control device 50B measures the time at which the first message transmitted from the control device 50A and relayed by the communication device 60 is received as second time information TB_1+1. Assume that the second time information TB_1+1, which is the reception time of the first message in step S33, is approximately 24 hours after the second time information TB_2 added to the first message in step S31, and the second expiration time has expired once between the second time information TB_2 in step S31 and the second time information TB_1+1 in step S33.

Here, in the example of FIG. 5, the first expiration time of the control device 50A is 24 hours, whereas the second expiration time of the control device 50B is 23 hours, which is one hour shorter than the first expiration time of the control device 50A. That is, the first expiration time of the control device 50A at the time of the first time information TA_2 and the second expiration time of the control device 50B at the time of the second time information TB_2 illustrated in step S31 have both expired, but the second expiration time of the control device 50B expires one hour earlier. Therefore, for the next first expiration time of the control device 50A and the next second expiration time of the control device 50B, that is, in and after step S32, the second time information based on the second expiration time of the control device 50B appears to be ahead of the first time information based on the first expiration time of the control device 50A, as compared with those with the previous first expiration time of the control device 50A and the previous second expiration time of the control device 50B. In the example of FIG. 5, a situation in which the second time information based on the second expiration time of the control device 50B appears to be ahead of the first time information based on the first expiration time of the control device 50A is expressed as the second time information “TB_1+1” in step S33.

The communication unit 51 of the control device 50B adds second time information TB_2+1 that is transmission time information to a second message that is a message to be transmitted, and transmits the second message (step S34). The communication device 60 relays the second message transmitted from the control device 50B to the control device 50A with a delay time of delay δ2 (step S35). The communication unit 51 of the control device 50A receives the second message transmitted from the control device 50B and relayed by the communication device 60.

Here, the communication device 60 relays the first message that has been received from the control device 50A in step S31 to the control device 50B with a delay time of 24 hours+delay δ3 (step S36). The time measuring unit 53 of the control device 50B measures the time at which the first message transmitted from the control device 50A and relayed by the communication device 60 is received as second time information TB_3+1.

The delay detection unit 52 of the control device 50B uses the first time information TA_1 and TA_2 and the second time information TB_1+1, TB_2, and TB_3+1 to determine whether or not formula (1) for checking the time information of the control device 50A and formula (2) for checking the ACKNOWLEDGE information are satisfied. At this time, formula (1) and formula (2) are as follows.

$$\vert ( ( TB\_ 3 + 1 ) - ( TB\_ 1 + 1 ) ) - ( TA\_ 2 - TA\_ 1 ) \vert = MOD ( 24 + δ3 , 24 ) - δ1 = δ3 - δ1 < ε1 \qquad ( 1 )$$

$$( TB\_ 3 + 1 ) - TB\_ 2 > ε2 \qquad ( 2 )$$

Thus, in the case where a delay of the same time as the first expiration time of the control device 50A has occurred in the communication device 60, the delay detection unit 52 of the control device 50B cannot detect from formula (1) that the delay has occurred in the communication device 60 as in the case of the example of FIG. 4. However, by using formula (2), the delay detection unit 52 of the control device 50B can detect that the delay has occurred in the communication device 60, unlike in the case of the example of FIG. 4.

The case where a delay of the same time as the first expiration time of the control device 50A has occurred in the communication device 60 has been described, but the present disclosure is not limited thereto. Even when a delay of the same time as the second expiration time of the control device 50B has occurred in the communication device 60, and when a delay of a time different from the first expiration time of the control device 50A and different from the second expiration time of the control device 50B has occurred in the communication device 60, the delay detection unit 52 of the control device 50B can detect that the delay has occurred in the communication device 60 by using formulas (1) and (2), detailed description of which using mathematical expressions is omitted. For example, when a delay of the same time as the second expiration time of the control device 50B has occurred in the communication device 60, the delay detection unit 52 of the control device 50B cannot detect from formula (2) that the delay has occurred in the communication device 60. However, by using formula (1), the delay detection unit 52 of the control device 50B can detect that the delay has occurred in the communication device 60.

In the control system 100, the control device 50A can detect a delay in a message transmitted and received from the control device 50B by performing the same operation as the operation of the control device 50B as described above.

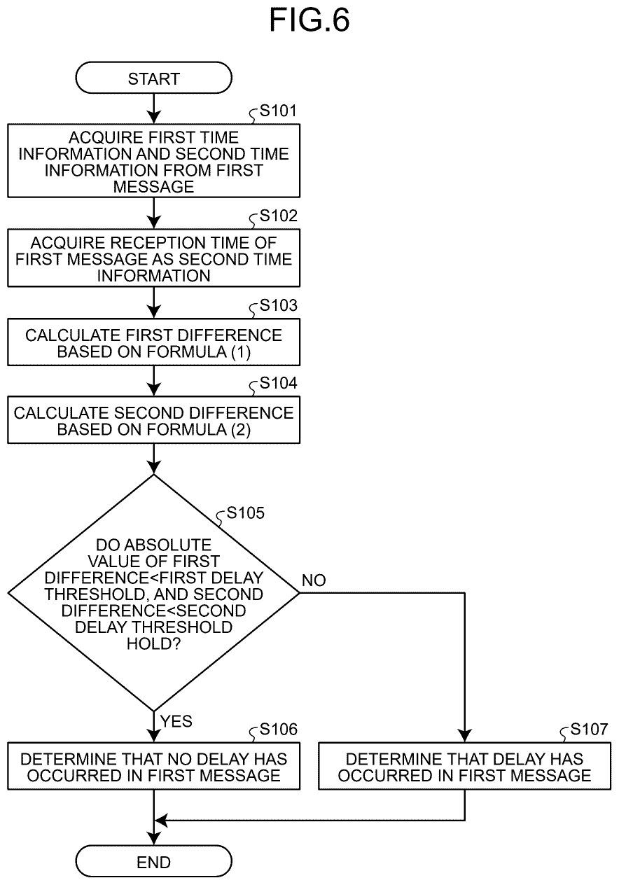

FIG. 6 is a flowchart illustrating the operation to detect a delay in a received message performed by the control device 50 according to the first embodiment. In the second control device, the communication unit 51 acquires first time information and second time information from a received first message (step S101). Specifically, when receiving a first message transmitted from the first control device, the communication unit 51 acquires first time information that is the transmission time of the first message added to the first message. In the case where second time information that is information on the transmission time of a transmitted second message is added to the received first message as ACKNOWLEDGE information, the communication unit 51 acquires the second time information as the ACKNOWLEDGE information added to the first message. The time measuring unit 53 measures the time when the first message is received, and acquires the reception time of the first message as second time information (step S102).

The delay detection unit 52 calculates a first difference based on formula (1) described above, using the second time information when a plurality of the first messages are received and the first time information added to each first message (step S103). The delay detection unit 52 calculates a second difference based on formula (2) described above, using the second time information at the time of receiving the first message to which the ACKNOWLEDGE information is added and the second time information that is the transmission time of the second message indicated by the ACKNOWLEDGE information (step S104). When the absolute value of the first difference is less than the first delay threshold and the second difference is less than the second delay threshold (step S105: Yes), the delay detection unit 52 determines that no delay has occurred in the first message (step S106). When at least one of the case where the absolute value of the first difference is greater than or equal to the first delay threshold, or the case where the second difference is greater than or equal to the second delay threshold applies (step S105: No), the delay detection unit 52 determines that a delay has occurred in the first message (step S107).

Thus, the delay detection unit 52 calculates the first difference between the difference in the second time information that is the difference between the latest second time information at the time of receiving the first latest message that is the latest first message and the previous second time information at the time of receiving the first previous message that is the first message, and the difference in the first time information that is the difference between the transmission time of the first latest message added to the first latest message and the transmission time of the first previous message added to the first previous message. The delay detection unit 52 calculates the second difference between the latest second time information and the previous second time information that is the second time information added to the first latest message and is the transmission time of the second latest message in the control device 50 added to the second latest message that is the latest second message received before the first control device transmits the first latest message. When the absolute value of the first difference is less than the specified first delay threshold, and the second difference is less than the specified second delay threshold, the delay detection unit 52 determines that no delay has occurred in the first message. When at least one of the case where the absolute value of the first difference is greater than or equal to the first delay threshold, or the case where the second difference is greater than or equal to the second delay threshold applies, the delay detection unit 52 determines that a delay has occurred in the first message.

Next, a hardware configuration of the control device 50 will be described. In the control device 50, the communication unit 51 is communication equipment that communicates with the communication device 60. The delay detection unit 52 and the time measuring unit 53 are implemented by processing circuitry. The processing circuitry may be a processor to execute a program stored in a memory and the memory, or may be dedicated hardware. The processing circuitry is also referred to as a control circuit.

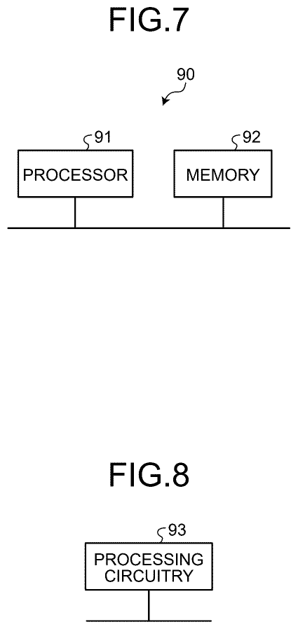

FIG. 7 is a diagram illustrating an exemplary configuration of processing circuitry 90 in the case where a processor 91 and a memory 92 constitute processing circuitry to implement the control device 50 according to the first embodiment. The processing circuitry 90 illustrated in FIG. 7 is a control circuit and includes the processor 91 and the memory 92. When the processor 91 and the memory 92 constitute the processing circuitry 90, functions of the processing circuitry 90 are implemented by software, firmware, or a combination of software and firmware. The software or firmware is described as a program and stored in the memory 92. In the processing circuitry 90, the processor 91 reads and executes the program stored in the memory 92, thereby implementing each function. That is, the processing circuitry 90 includes the memory 92 for storing the program that results in the execution of the processing in the control device 50. This program can be said to be a program for causing the control device 50 to perform the functions implemented by the processing circuitry 90. This program may be provided via a storage medium on which the program is stored, or may be provided via another means such as a communication medium.

The program can be said to be a program that causes the control device 50 to perform: a communication step in which the communication unit 51 receives a first message that is a message transmitted from the first control device via the communication device 60, and transmits a second message that is a message to the first control device via the communication device 60; a delay detection step in which the delay detection unit 52 detects a delay in the first message, using first time information when the first message was transmitted, the first time information being based on a first expiration time of the first control device and added to the first message, and second time information when the first message was received or the second message was transmitted, the second time information being based on a second expiration time of the control device 50 different from the first expiration time; and a time measuring step in which the time measuring unit 53 measures time using the second expiration time.

Here, the processor 91 is, for example, a central processing unit (CPU), a processing device, an arithmetic device, a microprocessor, a microcomputer, a digital signal processor (DSP), or the like. The memory 92 corresponds, for example, to nonvolatile or volatile semiconductor memory such as random-access memory (RAM), read-only memory (ROM), flash memory, an erasable programmable ROM (EPROM), or an electrically EPROM (EEPROM) (registered trademark), or a magnetic disk, a flexible disk, an optical disk, a compact disc, a mini disc, a digital versatile disc (DVD), or the like.

FIG. 8 is a diagram illustrating an example of processing circuitry 93 in the case where dedicated hardware constitutes the processing circuitry to implement the control device 50 according to the first embodiment. The processing circuitry 93 illustrated in FIG. 8 corresponds, for example, to a single circuit, a combined circuit, a programmed processor, a parallel-programmed processor, an application-specific integrated circuit (ASIC), a field-programmable gate array (FPGA), or a combination thereof. The processing circuitry may be implemented partly by dedicated hardware and partly by software or firmware. Thus, the processing circuitry can implement the above-described functions with dedicated hardware, software, firmware, or a combination thereof.

As described above, according to the present embodiment, in the control device 50, the delay detection unit 52 detects a delay in a first message, using first time information when the first message was transmitted, the first time information being based on the first expiration time of the first control device and added to the first message, and second time information when the first message was received or the second message was transmitted, the second time information being based on the second expiration time of the second control device as the control device 50 different from the first expiration time. In the control system 100, the control devices 50 measure time using different expiration times. This allows the control devices 50 to detect a delay in a received message without increasing the amount of information in messages.

### Second Embodiment

In the first embodiment, the control device 50 has been described on the assumption that the train control device 11 installed on the train 10 and the ground control device 21a or the ground control device 21c installed on the ground exchange messages. When viewed from the ground control device 21a or the ground control device 21c installed on the ground, the train control device 11 installed on the train 10 as a communication counterpart moves with the travel of the train 10, and thus the communication counterpart changes frequently. On the other hand, the ground control device 21a and the ground control device 21c also exchange messages. The ground control device 21a and the ground control device 21c are fixed and do not move, and thus continuously exchange messages. A second embodiment describes a case where the control device 50 detects whether or not the first expiration time of a first control device as a communication counterpart is proper when the first expiration time of the first control device is known.

In the second embodiment, the configuration of the control system 100 is the same as the configuration of the control system 100 of the first embodiment illustrated in FIG. 1. The configuration of the control device 50 is the same as the configuration of the control device 50 of the first embodiment illustrated in FIG. 2. Here, a description is given with the ground control device 21a as a first control device, and with the ground control device 21c as a second control device. In the present embodiment, when the first expiration time of the first control device is known, the delay detection unit 52 of the second control device determines whether or not the first expiration time has changed on the basis of first time information added to first messages. Cases where the first expiration time has changed include a case where the first expiration time, which is originally 24 hours, has been changed to 25 hours, and a case where the first expiration time is originally 24 hours, and how the time indicated by the first time information is expressed is not changed, but the unit time, for example, how one hour progresses has become faster or slower than before.

The delay detection unit 52 of the second control device may receive and hold information on the first expiration time of the first control device from a person in charge of managing the control system 100 or the like at the time of installation of the second control device and the first control device, or may calculate the first expiration time from the transmission interval between first messages received from the first control device in the past based on first time information added to the first messages. That is, the delay detection unit 52 of the second control device may hold the first expiration time of the first control device in advance, or may calculate the first expiration time after starting the transmission and reception of messages by receiving a plurality of first messages from the first control device.

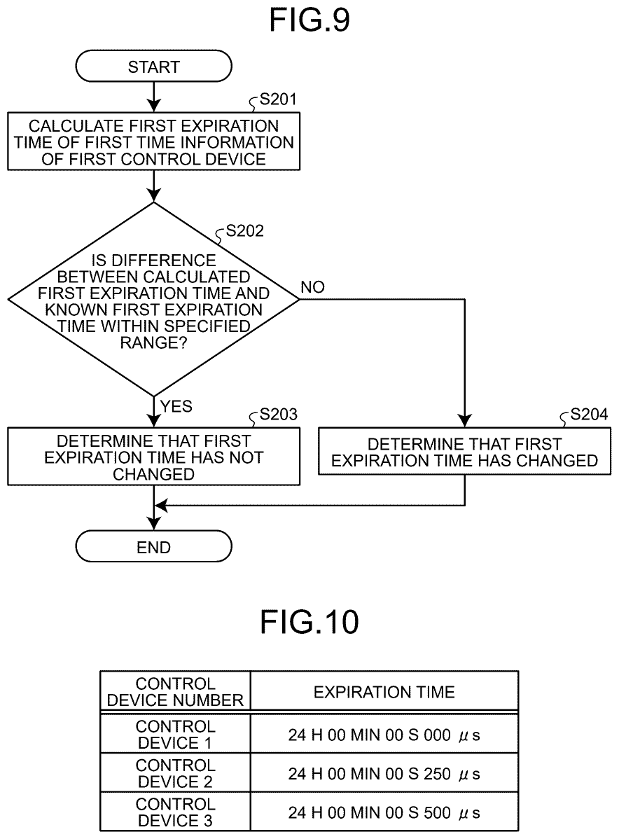

FIG. 9 is a flowchart illustrating an operation to detect a change in the expiration time of the control device 50 that is the source of messages, performed by the control device 50 according to the second embodiment. In the second control device, the delay detection unit 52 receives first messages transmitted from the first control device, and calculates the first expiration time of first time information of the first control device, using the first time information added to the first messages (step S201). If the difference between the calculated first expiration time and the known first expiration time is within a specified range (step S202: Yes), the delay detection unit 52 determines that the calculated first expiration time of the first time information of the first control device has not changed (step S203). If the difference between the calculated first expiration time and the known first expiration time is outside the specified range (step S202: No), the delay detection unit 52 determines that the calculated first expiration time of the first time information of the first control device has changed (step S204). The delay detection unit 52 of the second control device periodically performs the operation of the flowchart illustrated in FIG. 9.

As described above, in the present embodiment, for the first control device with which to continuously perform transmission and reception of messages, when the first expiration time is known, the delay detection unit 52 of the second control device can determine whether or not the first expiration time has changed on the basis of the first time information added to first messages. Consequently, when the delay detection unit 52 of the second control device determines that the first expiration time has changed in the first control device, for example, the delay detection unit 52 can provide a notification to the person in charge of managing the control system 100 or the like to make the condition of the first control device known.

The delay detection unit 52 of the second control device may hold an expiration time management table in which the first expiration time of the first control device is registered. FIG. 10 is a diagram illustrating an example of the expiration time management table held by the delay detection unit 52 of the control device 50 according to the second embodiment. In FIG. 10, control device numbers are for identifying first control devices, and are, for example, numbers assigned in the order in which the delay detection unit 52 of the second control device registers information on the first control devices and their first expiration times in the expiration time management table. In FIG. 10, expiration time indicate the first expiration time of each first control device. Although the delay detection unit 52 of the second control device manages three first expiration times of the first control devices in the example of FIG. 10, the number of first expiration times of first control devices to be managed is not limited to three. By holding the expiration time management table as illustrated in FIG. 10, the delay detection unit 52 of the second control device can easily manage the first expiration times of the first control devices.

The delay detection unit 52 of the second control device may acquire information to be registered in the expiration time management table from, for example, at least one of information on the first expiration time included in a message transmitted from the first control device when the first control device is activated, or information on the first expiration time included in a message periodically transmitted from the first control device. This allows the delay detection unit 52 of the second control device to acquire information to be registered in the expiration time management table without the person in charge of managing the control system 100 or the like setting the expiration time management table in advance. Furthermore, even when a new first control device is added during the operation of the control system 100, the delay detection unit 52 of the second control device can acquire information on the first expiration time from the added first control device, and thus can flexibly respond.

Here, when the second control device is newly activated in a situation where the first control device periodically transmits a message including information on the first expiration time as described above, the delay detection unit 52 of the second control device may check the information on the first expiration time included in the message acquired from the first control device and set the second expiration time different from the first expiration time. Thus, the delay detection unit 52 of the second control device can set the second expiration time different from the first expiration time of the first control device without adjustment by the person in charge of managing the control system 100 or the like. That is, in the control system 100, a plurality of the control devices 50 can set different expiration times.

In the control system 100, the control device 50 newly activated may output a message requesting the acquisition of the expiration time to the control device 50 to communicate at the time of activation, and the control device 50 that has received the message requesting the acquisition of the expiration time may return information on its expiration time. Thus, the control device 50 newly activated may collect information on the expiration times of the control devices 50 to communicate. That is, when acquiring a message requesting the acquisition of the second expiration time from the newly activated first control device via the communication unit 51, the delay detection unit 52 of the second control device performs control to transmit a message including information on the second expiration time from the communication unit 51 to the newly activated first control device. Alternatively, when the second control device is newly activated, the delay detection unit 52 of the second control device performs control to transmit a message requesting the acquisition of the first expiration time to the first control device via the communication unit 51, and acquires a message including information on the first expiration time from the first control device via the communication unit 51. This can eliminate the need for the control device 50 to place expiration time information on a periodically transmitted message, and thus the control system 100 can reduce communication load. Furthermore, the control device 50 does not need to place expiration time information on a periodically transmitted message, and thus does not need to change the format of the periodically transmitted message.

Although the case where the delay detection unit 52 of the second control device holds the expiration time management table illustrated in FIG. 10 has been described, the present disclosure is not limited thereto. Each control device 50 of the control system 100 may include expiration time information in a periodically transmitted message, so that the delay detection unit 52 of the second control device detects a delay in a first message, based on information on the first expiration time included in a message periodically transmitted from the first control device. This eliminates the need for the delay detection unit 52 of the second control device to use the expiration time management table as illustrated in FIG. 10, so that the control system 100 can easily manage the control devices 50.

The configurations described in the above embodiments illustrate an example, and can be combined with another known art. The embodiments can be combined with each other. The configurations can be partly omitted or changed without departing from the gist.

### REFERENCE SIGNS LIST

10 train; 11 train control device; 12 on-board wireless device; 13, 23a to 23c antenna; 21a, 21c ground control device; 22a to 22c ground wireless device; 24a, 24c, 25a to 25c layer 2 switch; 30a to 30c communication area; 40 track; 50, 50A, 50B control device; 51 communication unit; 52 delay detection unit; 53 time measuring unit; 60 communication device; 100 control system.

1. A control device that is a second control device in a control system in which a first control device and the second control device transmit and receive a message via a communication device, the control device comprising:
a communication unit to receive a first message that is the message transmitted from the first control device via the communication device, and transmit a second message that is the message to the first control device via the communication device;
delay detection circuitry to detect a delay in the first message, using first time information when the first message is transmitted, the first time information being based on a first expiration time of the first control device and added to the first message, and second time information when the first message is received or the second message is transmitted, the second time information being based on a second expiration time of the control device different from the first expiration time; and
time measuring circuity to measure time using the second expiration time.

2. The control device according to claim 1, wherein
the delay detection circuitry determines that no delay has occurred in the first message when
an absolute value of a first difference between a difference in the second time information that is a difference between latest second time information when a first latest message that is the latest first message is received and previous second time information when a first previous message that is the previous first message is received, and a difference in the first time information that is a difference between a transmission time of the first latest message added to the first latest message and a transmission time of the first previous message added to the first previous message, is less than a specified first delay threshold, and
a second difference between the latest second time information and previous second time information that is the second time information added to the first latest message and is a transmission time of a second latest message in the control device added to the second latest message that is the latest second message received by the first control device before transmitting the first latest message, is less than a specified second delay threshold, and
the delay detection circuitry determines that a delay has occurred in the first message when at least one of a case where the absolute value of the first difference is greater than or equal to the first delay threshold, or a case where the second difference is greater than or equal to the second delay threshold applies.

3. The control device according to claim 1, wherein
the delay detection circuitry determines whether or not the first expiration time has changed, based on the first time information added to the first messages, when the first expiration time of the first control device is known.

4. The control device according to claim 1,
wherein
the delay detection circuitry holds an expiration time management table in which the first expiration time of the first control device is registered.

5. The control device according to claim 4, wherein
the delay detection circuitry acquires information to be registered in the expiration time management table from at least one of information on the first expiration time included in a message transmitted from the first control device when the first control device is activated, or information on the first expiration time included in a message periodically transmitted from the first control device.

6. The control device according to claim 5, wherein
the delay detection circuitry checks the information on the first expiration time included in the message acquired from the first control device and sets the second expiration time different from the first expiration time, when the control device is newly activated in a situation where the first control device periodically transmits the message including the information on the first expiration time.

7. The control device according to claim 5, wherein
the delay detection circuitry performs control to transmit a message including information on the second expiration time from the communication unit to the first control device newly activated, when the delay detection circuitry acquires a message requesting acquisition of the second expiration time from the first control device newly activated via the communication unit.

8. The control device according to claim 5, wherein
when the control device is newly activated, the delay detection circuitry performs control to transmit a message requesting acquisition of the first expiration time to the first control device via the communication unit, and acquires the message including the information on the first expiration time from the first control device via the communication unit.

9. The control device according to claim 1,
wherein
the delay detection circuitry detects a delay in the first message, based on information on the first expiration time included in a message periodically transmitted from the first control device.

10. A control system comprising:
a first control device; and
a second control device that is the control device according to claim 1, wherein
a first expiration time of first time information when a first message to be transmitted by the first control device is transmitted, the first time information being added to the first message, is different from a second expiration time of second time information when the second control device receives the first message or transmits a second message.

11. A message delay detection method for a control device that is a second control device in a control system in which a first control device and the second control device transmit and receive a message via a communication device, the method comprising:
a communication of receiving a first message that is the message transmitted from the first control device via the communication device, and transmitting a second message that is the message to the first control device via the communication device;
a delay detection step of detecting a delay in the first message, using first time information when the first message is transmitted, the first time information being based on a first expiration time of the first control device and added to the first message, and second time information when the first message is received or the second message is transmitted, the second time information being based on a second expiration time of the control device different from the first expiration time; and
a time measuring of measuring time using the second expiration time.

12. The message delay detection method according to claim 11, wherein
the delay detection includes
determining that no delay has occurred in the first message when
an absolute value of a first difference between a difference in the second time information that is a difference between latest second time information when a first latest message that is the latest first message is received and previous second time information when a first previous message that is the previous first message is received, and a difference in the first time information that is a difference between a transmission time of the first latest message added to the first latest message and a transmission time of the first previous message added to the first previous message, is less than a specified first delay threshold, and
a second difference between the latest second time information and previous second time information that is the second time information added to the first latest message and is a transmission time of a second latest message in the control device added to the second latest message that is the latest second message received by the first control device before transmitting the first latest message, is less than a specified second delay threshold, and
determining that a delay has occurred in the first message when at least one of a case where the absolute value of the first difference is greater than or equal to the first delay threshold, or a case where the second difference is greater than or equal to the second delay threshold applies.

13. The message delay detection method according to claim 11, wherein
the delay detection includes determining whether or not the first expiration time has changed, based on the first time information added to the first messages, when the first expiration time of the first control device is known.

14. The message delay detection method according to claim 11, wherein
the delay detection includes holding an expiration time management table in which the first expiration time of the first control device is registered.

15. The message delay detection method according to claim 14, wherein
the delay detection includes acquiring information to be registered in the expiration time management table from at least one of information on the first expiration time included in a message transmitted from the first control device when the first control device is activated, or information on the first expiration time included in a message periodically transmitted from the first control device.

16. The message delay detection method according to claim 15, wherein
the delay detection includes checking the information on the first expiration time included in the message acquired from the first control device and setting the second expiration time different from the first expiration time, when the control device is newly activated in a situation where the first control device periodically transmits the message including the information on the first expiration time.

17. The message delay detection method according to claim 15, wherein
the delay detection includes performing control to transmit a message including information on the second expiration time to the first control device newly activated, when a message requesting acquisition of the second expiration time is acquired from the first control device newly activated.

18. The message delay detection method according to claim 15, wherein
the delay detection includes when the control device is newly activated, performing control to transmit a message requesting acquisition of the first expiration time to the first control device, and acquiring the message including the information on the first expiration time from the first control device.

19. The message delay detection method according to claim 11, wherein
the delay detection includes detecting a delay in the first message, based on information on the first expiration time included in a message periodically transmitted from the first control device.
